(19) United States
(12) Patent Application Publication
(10) Pub. No.: US 2006/0011246 A1
(43) Pub. Date: Jan. 19, 2006

(54) Fluid flow control system and method

(76) Inventor: John A. Leys, Chaska, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/177,236

(22) Filed: Jul. 8, 2005

Related U.S. Application Data
(60) Provisional application No. 60/586,784, filed on Jul. 9, 2004.

(51) Int. Cl. F17D 1/00

(52) U.S. Cl. 137/884

(57) ABSTRACT

A fluid flow control system including a subassembly having a plurality of fluid flow component bases coupled with at least one fluid conduit to define a fluid flow path. The system further includes fluid flow components that are configured to couple selective fluid flow component bases on the subassembly such that the fluid flow components are in fluid communication with each other along the fluid flow path. The system also includes a channel block having a recess, wherein the fluid flow component bases are configured to be at least partially nested within the recess.

### RELATED APPLICATION

The present application claims the benefit of U.S. Provisional Application No. 60/586,784 filed Jul. 9, 2004, entitled “IMPROVED FLUID FLOW CONTROL SYSTEM COMPONENTRY AND METHOD OF ASSEMBLING THE SAME,” which is incorporated herein in its entirety by reference.

### FIELD OF THE INVENTION

The present invention relates to fluid flow control systems for fluid flow processes. More particularly, the present invention relates to a system and method for integrating flow control and monitoring components for use in the semiconductor industry.

### BACKGROUND OF THE INVENTION

Modular systems have been devised for monitoring and controlling high purity gases during semiconductor manufacturing. The systems are compact and provide flexibility to allow users to assemble custom fluid flow component integrations and configurations.

Some systems utilize machined blocks that mate directly together and do not require the use of interconnecting tubes. These blocks are often machined or otherwise formed with flow passages and sealing gland interfaces, which can increase fabrication costs. In addition, the blocks are often fabricated from high purity metal, which can further increase the cost of material. In some systems, a bulk of the high purity metal is not necessary as much of the block material is generally not serving any purpose.

Other systems utilize interconnecting tubes between fittings. These systems often route the fluid through the bottom of the component through fittings and/or un-shaped jumpers or interconnecting bridge fittings. These configurations can add to head loss through an integrated assembly.

There is currently a need for a fluid flow control apparatus and method for integrating flow control and monitoring components that addresses the inherent deficiencies that are present with conventional designs.

### SUMMARY OF THE INVENTION

The fluid flow control system of the present invention substantially solves the problems with conventional designs by providing a system and method for integrating multiple flow control and monitoring components for use in the semiconductor industry in a modular assembly.

In an embodiment, the fluid flow control system can comprise a subassembly having a plurality of fluid flow component bases operably coupled with at least one fluid conduit defining a fluid flow path there through. The fluid flow control system can includes a plurality of fluid flow components configured to couple selective fluid flow component bases on the subassembly such that the fluid flow components are in fluid communication with each other along the fluid flow path. The fluid flow control system can further include a channel block having a longitudinal axis and a recess defined therein extending along the longitudinal axis, wherein the fluid flow component bases are configured to be at least partially nested within the recess.

In another embodiment, a method of using a fluid flow control system comprising providing a plurality of fluid flow components, a subassembly comprising a plurality of fluid flow component bases configured to couple selective fluid flow components, and at least one fluid conduit. The method also can include operably coupling the plurality of fluid flow component bases and fluid conduit to define a fluid flow path there through. The method can further include providing a channel block having a longitudinal axis and a recess defined therein extending along the longitudinal axis, operably nesting the fluid flow component bases at least partially within the recess, and operably coupling the plurality of fluid flow components to selective fluid flow component bases such that the selective fluid flow components are in fluid communication with each other along the fluid flow path.

In another embodiment, the fluid flow control system can comprise a subassembly having a plurality of fluid flow component bases operably coupled with at least one fluid conduit to define a fluid flow path. The fluid flow control system can also include a plurality of fluid flow components configured to couple selective fluid flow component bases on the subassembly such that the selective fluid flow components are in fluid communication with each other along the fluid flow path. The fluid flow control system can further include a channel block matrix having a first recess and a second recess defined therein defined therein, wherein the fluid flow component bases are configured to be at least partially nested within the recesses.

In a further embodiment, a fluid flow control subassembly can comprise a plurality of fluid flow component bases operably coupled with at least one fluid conduit defining a fluid flow path there through, the bases each defining at least a portion of an operative portion of a respective fluid flow component.

A feature and advantage of fluid flow control system according to the various embodiments is that it enables the modular exchange and/or replacement of flow control/monitoring components that possess identical bridge mounts or ports.

Another feature and advantage of fluid flow control system according to the various embodiments is that the flow path defined between the fluid flow components can be direct, thereby reducing any head loss that can be associated with tubular jumper connectors.

Another feature and advantage of fluid flow control system according to the various embodiments is that the fluid flow control system can be low profile because portions of the fluid flow components can nest within a recess defined on the channel. This enables installation and/or placement in areas having limited space.

### BRIEF DESCRIPTION OF THE FIGURES

FIG. 1 is an exploded perspective view depicting a fluid flow control system according to an embodiment of the present invention;

FIG. 2 is a partial cross-section side elevational view depicting a fluid flow control system according to an embodiment of the present invention;

FIG. 3 is a top plan view depicting a fluid flow control system according to an embodiment of the present invention;

FIG. 4 is an elevational end view depicting a fluid flow control system according to an embodiment of the present invention;

FIG. 5 is a perspective view depicting a subassembly according to an embodiment of the present invention;

FIG. 6a is cross-sectional view depicting a bridge mount and hand valve according to an embodiment of the present invention;

FIG. 6b is cross-sectional view depicting a bridge mount and regulator according to an embodiment of the present invention;

FIG. 6c is cross-sectional view depicting a bridge mount and actuator according to an embodiment of the present invention;

FIG. 7a is cross-sectional view depicting a channel according to an embodiment of the present invention;

FIG. 7b is cross-sectional view depicting a channel according to an embodiment of the present invention, a bridge mount or port depicted in phantom lines;

FIG. 7c is cross-sectional view depicting a channel according to an embodiment of the present invention, a bridge mount or port depicted in phantom lines;

FIG. 8 is an exploded perspective view depicting a fluid flow control system according to an embodiment of the present invention; and

FIG. 9a is a top plan view depicting a fluid flow control system according to an embodiment of the present invention;

FIG. 9b is an elevational end view depicting a fluid flow control system according to an embodiment of the present invention;

FIG. 9c is an elevational end view depicting a fluid flow control system according to an embodiment of the present invention; and

FIG. 10 is cross-sectional view depicting a channel matrix according to an embodiment of the present invention.

### DETAILED DESCRIPTION OF THE INVENTION

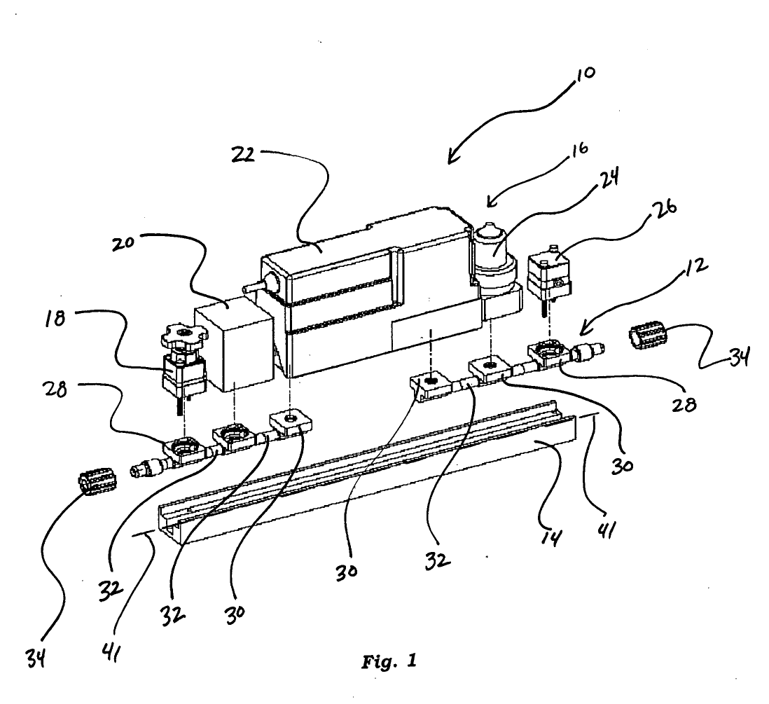

Referring to FIG. 1, a fluid flow control system according to exemplary embodiments is depicted and is generally indicated by the numeral 10. The principle components of the fluid flow control system 10 are a subassembly 12, a channel block 14, and fluid flow components 16. Such fluid flow components 16 include, but are not limited to, valves 18, regulators 20, flow controllers 22, pressure transducers 24, actuators 26, or other various fluid flow components used by those of skill in the art in fluid monitoring or control.

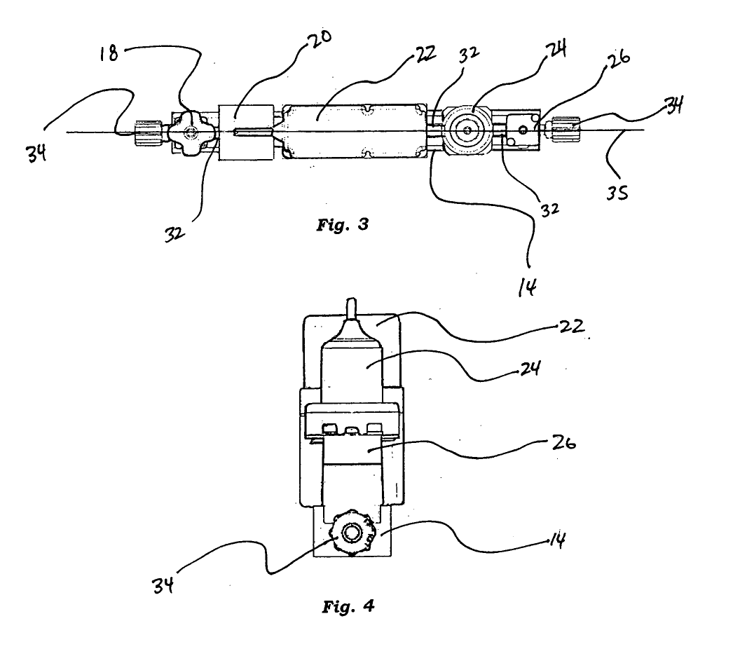

As depicted in FIGS. 1-4, the in-line fluid flow control system 10 includes a variety of fluid flow components 16 connected in series. From left to right, the components are a hand valve 18, regulator 20, an Integrated Flow Controller (IFC) 22, a pressure transducer 24, and an actuator 26.

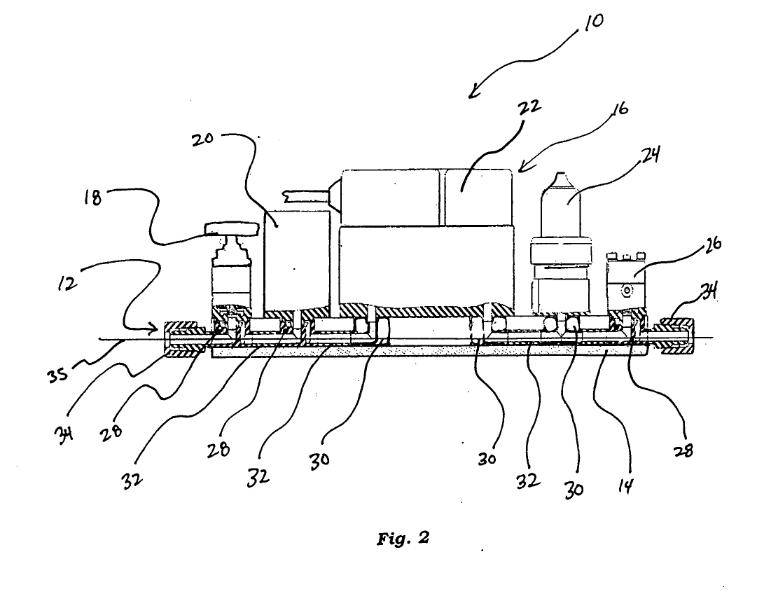

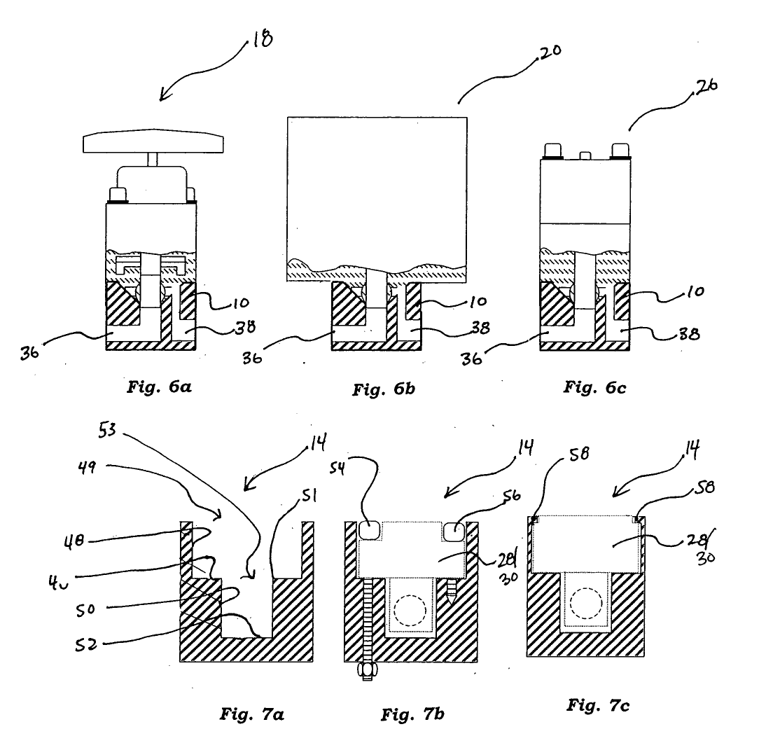

Referring to FIGS. 2 and 6a-6c, fluid control components 16 often include bridge mounts 28 or ports 30 through which fluid can enter and/or exit. Active control components, such as valves 18, regulators 20, and actuators 26, can include bridge mounts 28. The bridge mounts 28 can be the lower portion or base of the active fluid control component through which a fluid enters and exits. The bridge mounts 28 can also define a portion of the inner valve chamber and/or a valve seat. FIGS. 6a-6c depict, respectively, a hand valve 18, a regulator 20, and an actuator 26, including their respective bridge mounts 28. Fluid control components 16 can include standard or identically configured bridge mounts 10, such that the components 16 can be easily interchanged or replaced while the interconnecting plumbing remains in place. Accordingly, a plumbing line or network having a number of such bridge mounts 28 can be regarded as “receptacles” for the modular placement of fluid flow components 16 in a desired sequence. As depicted in FIGS. 6a-6c, the bridge mounts can have an inlet 36 and an outlet 38 through which fluid can enter and exit the bridge mount, respectively.

Referring to FIGS. 2 and 6a-6c, other fluid flow components can include a port 30 or ports through which fluid can enter and/or exit the component 16. The ports 30 can be the lower portion or base of the active fluid control component 16 through which a fluid enters and exits For example, as depicted in the figures, the IFC 22 and pressure transducer 24 include ports 30. As depicted, the ports 30 differ from the configuration of bridge mounts 28. Referring to FIG. 2, the ports 30 include an inlet/outlet 40. The inlet/outlet 40 can be L-shaped or T-shaped depending on the application or placement of the port within the subassembly 12.

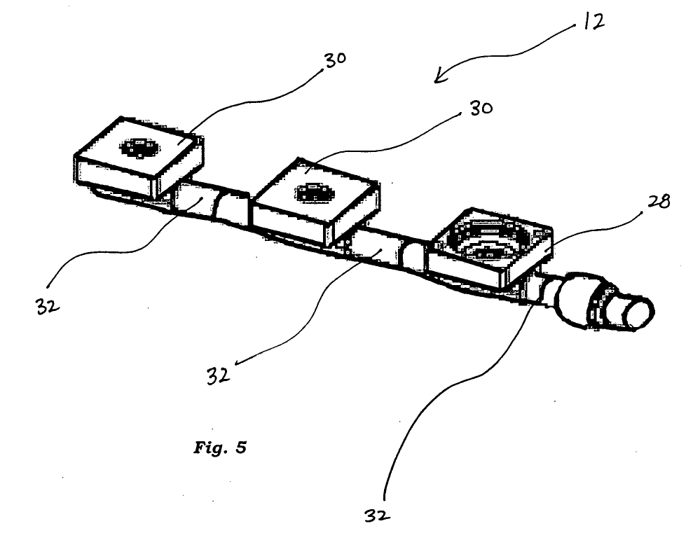

As depicted in FIGS. 1 and 5, the ports 30 and bridge mounts 28 can be interconnected by fluid conduits 32 or tubulations and the subassembly can be terminated with one or more compression fittings 34. These components are can collectively constitute the subassembly 12 or “wetted subassembly.” The various components of the subassembly 12 can be constructed of various metals, such as stainless steel, or polymers, such as various fluoropolymers (e.g., DuPont® Teflon® polytetrafluoroethylene), or any other suitable material, such as materials suitable for use during semiconductor processing known to those of skill in the art. If constructed of metal, the subassembly 12 can be rigid. The components of the subassembly 12 can be constructed by any method known to those skilled in the art, including, but not limited to, extrusion, molding, forging, and casting.

In the semiconductor industry, subassembly 12 is often constructed of DuPont® Teflon® polytetrafluoroethylene (PTFE) or some other fluoropolymer, thus, in some embodiments, can require added structural stability and support. Referring to FIG. 1, in these embodiments, a channel 14 or channel rail can be included to provide additional stability and support for the subassembly 12. As depicted in FIGS. 1 and 7a, the channel 12 includes a channel axis 41 and can be formed to include two joining recesses, i.e., a first or upper recess 42 and a second or lower recess 44. While the recesses are described herein as upper and lower recesses 42, 44, the channel can be oriented such that the first and second recesses 42, 44 are oriented outwardly in either direction or downwardly. As such, the upper and lower recesses 42, 44 are described as such for the orientation as depicted in FIG. 7a. The recesses are described in this manner for convenience but are not to be construed to be limited to such an orientation. In addition, while the channel 14 is depicted as including two recesses 42, 44, the channel 14 can include only one recess or more than two recesses without departing from the scope and spirit of the present application.

Referring to FIG. 7a, the upper recess 12 includes a base surface or floor 46, two generally opposed walls or sides 48, and an open top or ceiling 49. Likewise, the lower recess 44, which depicted as being wider than the upper recess 42, also includes a base surface 50, two generally opposed sides 52, and an top or opening 53 that can be centered on floor 46 of the upper recess 42. The convolution of the recesses 42, 44 can form a T-shaped void. Thus the floor 46 of upper recess 42 can form two shoulders 51 that can straddle the opening 53 of the lower recess 44. In other embodiments, the channel 14 is not angled but rather rounded to correspond to rounded edges of components included on the subassembly 12. In addition, while the channel 14 is depicted as being unitary and integral, the channel 14 can include multiple channel portions that are configured to operably couple to form an integral channel 14.

The channel 14 can be constructed of metal, such as stainless steel, or polymer, such as various fluoropolymers (e.g., DuPont® Teflon® polytetrafluoroethylene) or any other suitable material providing additional stability and support for the subassembly 12. Depending on the application, the channel 14 can be constructed of the same material as the subassembly 12 or can be constructed of a different material than the subassembly 12. For example, the subassembly 12 can be constructed of a fluoropolymer while the channel 14 is constructed of a metal, or both the 12 subassembly and channel 14 can be constructed of the same material, such as a fluoropolymer or of a metal. The channel 14 can be constructed by any method known to those skilled in the art, including, but not limited to, extrusion, molding, forging, and casting.

While the channel 14 is depicted as being linear in shape, the channel 14 can include bends or curves without departing from the scope of the present application. For example, the channel 14 can be L-shaped, S-shaped, C-shaped, circular, square, or other shaped configurations. In addition, while the channel 14 is depicted as being generally flat, the channel can be curved, bowed, or otherwise shaped in order to be placed on and mate with a non-flat surface.

Various flow control or monitoring components 16 can be coupled or secured to and nest within the channel 14. Referring to FIGS. 2-4, the bridge mounts 28 and ports 30 of the respective flow control components 16 can be configured to fit within the void created by the recesses 42, 44. As depicted in FIG. 2-4, because a portion of the fluid flow components (e.g., bridge mount 28 or port 30) nests into the recesses 42, 44 on the channel 14, the fluid flow control system 10 in its assembled configuration has a low profile. The low profile enables the fluid flow control system 10 to be placed in locations having otherwise limited clearance or space. The low profile also provides a direct flow path, thereby reducing any head loss.

Various mechanisms for securing the bridge mounts 28 and ports 30 to the channel 14 are depicted in FIGS. 7b and 7c. As depicted in FIG. 7b, the bridge mounts 28 and ports 30 can be secured to the floor 46 by a fastening assembly, such as a fastener/nut assembly 54 and/or a fastener/tapped hole assembly 56. Referring to FIG. 7c, the interior surfaces of sides 48 can include lips or protrusions 58 that are formed with or attached to sidewalls 48. In another embodiment, the lips or protrusions 58 can be formed with or attached to sidewalls 52 of the bottom recess. The bridge mounts 28 (depicted in phantom in FIGS. 7b and 7c) can be captured within the channel 14 by the snapping into the channel 14 by the lips 58 or by sliding the assembled subassembly 12 into the channel 14 from the ends.

While the lips 58 are depicted as being inwardly directed, the lips 58 can be oriented upwardly, outwardly, or downwardly without departing from the scope and spirit of the present application.

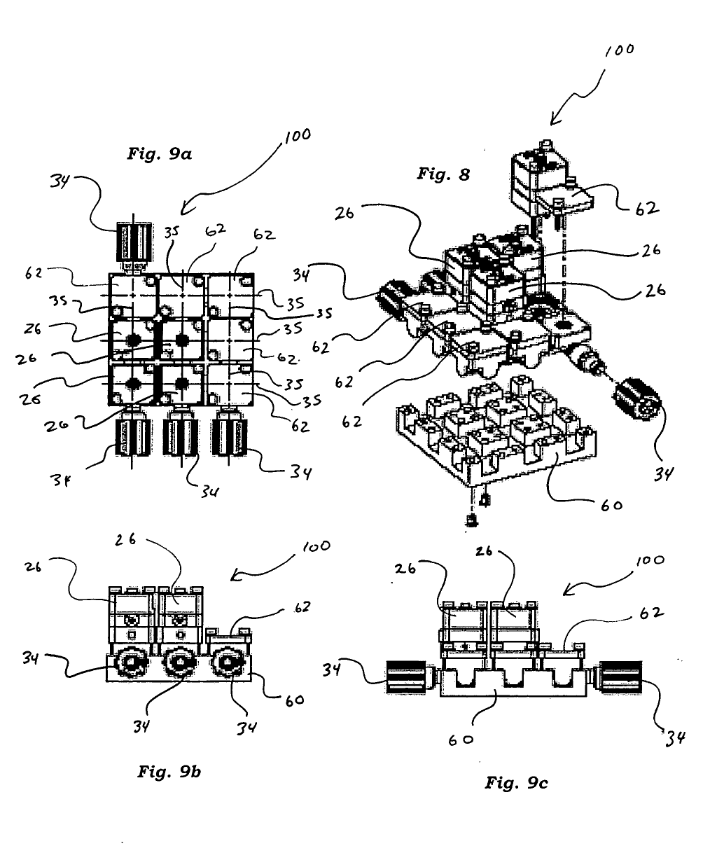

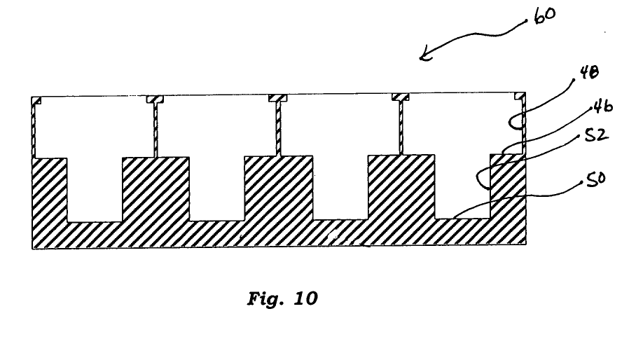

Referring to FIGS. 8 and 9a-9c, another embodiment of the fluid flow control system is depicted and is generally indicated by the numeral 100. In this embodiment, the various fluid flow components 16 can be mounted to a channel matrix 60. The channel matrix 60 configuration enables fluids to be routed alternatively or simultaneously through multiple flow branches or flow paths 35. The particular embodiment depicted in the FIG. 8 includes multiple actuators 26 for an on/off control of multiple flow streams. In other embodiments, the channel matrix can include any desired combination of fluid flow components, including, but not limited to, hand valves 18, regulators 20, IFCs 22, pressure transducers 24, and/or actuators 26.

Also, a system 100 can possess additional flexibility as a port 30 or bridge mount 28 can be located at every node within the channel matrix 60. When a port 30 or bridge mount 28 is not occupied by a component 16, the port 30 or bridge mount 28 can be blanked off or blocked using a blind flange 62. The blind flange 62 enables flow to continue through selective flow paths but inhibits flow through a port 30 or bridge mount 28 having a blind flange 62. The channel matrix 60 can be used for any number of combinations of fluid flow components and can be configured in multiple shapes. While the channel matrix 60 is depicted as being square in shape, it can be rectangular, T-shaped, L-shaped, or any other shape that is desired for a given application or location.

In the embodiment depicted in FIG. 8, the components 16 are mounted with fastener/tapped hole arrangement 56. Also, as depicted, the channel 60 does not include an upper recess 42, but rather only a single lower recess 42. Referring to FIG. 10, a dual level channel matrix 60 is depicted. In this embodiment, each channel in the channel matrix includes an upper and lower recess 42, 44.

To assembly a modular fluid flow control system 10 according to the various embodiments, first a plurality of bridge mounts 28 and/or ports are operably coupled to or connected with one ore more fluid conduits or tubulations 32. The connected components form the subassembly 12.

If the components of the subassembly are metallic, the interconnection may be done by conventional pipe fitting mechanisms known to those of ordinary skill in the art, such as brazing, soldering or welding. Releasable connections, such as flared fittings, compression fittings or pipe threads can also be used.

If the components are made of DuPont® Teflon® polytetrafluoroethylene or some other fluoropolymer, conventional gluing or bonding techniques can be used if it is compatible with the process stream to be controlled. In other embodiments, the fluid conduits or tubulations 34 can be connected to each other or to ports 30 or bridge mounts 28 by polymer welding, such as the welding described in U.S. Pat. No. 4,929,293, which is incorporated herein by reference in its entirety.

After the subassembly 12 has been assembled, it can then be mounted to the channel or channel matrix, depending on the application. The mounting can be done using the techniques depicted in FIGS. 6a-6c and as described above. In addition, the subassembly 12 can be operably coupled to the channel 14 or channel matrix 60 using other mechanism, such as gluing, taping, hook and loop fasteners (e.g., Velcro®), or other fixations mechanisms known to those of ordinary skill in the art.

Either before or after the subassembly 12 has been operably coupled to the channel 14 or channel matrix 60, the fluid flow components 16 can be operably coupled to the subassembly 12 at selective locations along the subassembly. Any unused ports 30 or bridge mounts 28 can then be blanked off with blind flanges 62. As depicted in FIGS. 2-3 and 8, the assembled fluid flow control system according to various embodiments can have one or more fluid flow paths or axes 35 defined therein along which fluid can flow. Referring to FIG. 8, the fluid flow paths 35 are depicted as being at right angles with respect to one another. In other embodiments, the fluid flow paths can be at right angles or angles greater to or less than right angles with respect to one another. This allows the fluid to be controlled in two paths 35 in any angular relationship from zero degrees to one hundred and eighty degrees.

Once the fluid flow control system 10 has been assembled, a user can then monitor and or control the fluid flow through the fluid flow control system 10. Also, a user can remove, replace, change, or otherwise displace various components 16 because of the common bridge mounts 28 or ports 30 provided on the subassembly. This enables a user to do any removal or replacement without affecting the plumbing of the fluid flow control system 10.

While the method of assembling the fluid flow control system 10, subassembly 12, and channel 14 has been described in an order, the order of the various assembly steps can be modified without departing from the scope and spirit of the present application.

Although the present invention has been described with reference to particular embodiments, one skilled in the art will recognize that changes may be made in form and detail without departing from the spirit and the scope of the invention. Therefore, the illustrated embodiments should be considered in all respects as illustrative and not restrictive.

What is claimed is:

1. A fluid flow control system comprising:
a subassembly having a plurality of fluid flow component bases operably coupled with at least one fluid conduit defining a fluid flow path there through;
a plurality of fluid flow components configured to couple selective fluid flow component bases on the subassembly such that the fluid flow components are in fluid communication with each other along the fluid flow path; and
a channel block having a longitudinal axis and a recess defined therein extending along the longitudinal axis, wherein the fluid flow component bases are configured to be at least partially nested within the recess.

2. The system of claim 1, wherein the fluid flow components are selected from the group consisting of:
valve;
regulator;
flow controller;
pressure transducer; and
actuator.

3. The system of claim 1, wherein the subassembly is operably coupled to the channel block.

4. The system of claim 1, wherein the recess comprises an upper recess portion and a lower recess portion, each recess portion comprising a base surface and a pair of generally opposed side surfaces.

5. The system of claim 4, wherein the fluid flow component bases are operably coupled to the base surface of the upper recess portion.

6. The system of claim 4, wherein the fluid flow component bases are operably coupled to the base surface of the upper recess portion with a fastening assembly.

7. The system of claim 1, wherein the recess comprises an inwardly facing lip.

8. The system of claim 7, wherein the fluid flow component bases are operably coupled to the base surface of the upper recess with the inwardly facing lip.

9. The system of claim 1, wherein the subassembly is made of polytetrafluoroethylene.

10. A method of using a fluid flow control system comprising:
providing a plurality of fluid flow components, a subassembly comprising a plurality of fluid flow component bases configured to couple selective fluid flow components, and at least one fluid conduit;
operably coupling the plurality of fluid flow component bases and fluid conduit to define a fluid flow path there through;
providing a channel block having a longitudinal axis and a recess defined therein extending along the longitudinal axis;
operably nesting the fluid flow component bases at least partially within the recess; and
operably coupling the plurality of fluid flow components to selective fluid flow component bases such that the selective fluid flow components are in fluid communication with each other along the fluid flow path.

11. The method of claim 10, further comprising operably coupling the subassembly to the channel block.

12. The method of claim 10, further comprising monitoring a fluid flow along the fluid flow path.

13. The method of claim 10, further comprising controlling a fluid flow along the fluid flow path.

14. The method of claim 10, further comprising:
providing the recess with an upper recess portion and a lower recess portion, each recess portion comprising a base surface and a pair of generally opposed side surfaces; and
operably coupling one or more of the plurality of fluid flow components to the base surface of the upper recess portion.

15. A fluid flow control system comprising:
a subassembly having a plurality of fluid flow component bases operably coupled with at least one fluid conduit to define a fluid flow path;
a plurality of fluid flow components configured to couple selective fluid flow component bases on the subassembly such that the selective fluid flow components are in fluid communication with each other along the fluid flow path; and
a channel block matrix having a first recess and a second recess defined therein defined therein, wherein the fluid flow component bases are configured to be at least partially nested within the recesses.

16. The system of claim 15, wherein the first and second recesses are substantially parallel.

17. The system of claim 15, wherein the first and second recesses are generally at an angle with respect to each other.

18. A fluid flow control subassembly comprising a plurality of fluid flow component bases operably coupled with at least one fluid conduit defining a fluid flow path there through, the bases each defining at least a portion of an operative portion of a respective fluid flow component.

19. The subassembly of claim 18, wherein the respective fluid flow components are selected from the group consisting of:
valve;
regulator;
flow controller;
pressure transducer; and
actuator.

20. The subassembly of claim 18, further comprising a channel having a recess defined therein, the channel operably coupled to the fluid flow component bases, such that the fluid flow component bases are at least partially nested within the recess.
